(19) United States
(12) Patent Application Publication
(10) Pub. No.: US 2014/0184163 A1
(43) Pub. Date: Jul. 3, 2014

(54) BATTERY CHARGE MANAGEMENT FOR ELECTRONIC DEVICE

(71) Applicants: RIPAN DAS, Beaverton, OR (US); NAGASUBRAMANIAN GURUMOORTHY, Portland, OR (US); ANDY KEATES, Los Gatos, CA (US)

(72) Inventors: RIPAN DAS, Beaverton, OR (US); NAGASUBRAMANIAN GURUMOORTHY, Portland, OR (US); ANDY KEATES, Los Gatos, CA (US)

(21) Appl. No.: 13/729,202

(22) Filed: Dec. 28, 2012

(51) Int. Cl. H02J 7/00

(52) U.S. Cl. CPC H02J 7/007
USPC 320/134; 320/128

(57) ABSTRACT

In one embodiment a method comprises receiving, in the controller, a user profile for usage of an electronic device, the electronic device at least partially powered by a battery and implementing, in the controller, a selected charge routine from a plurality of charge routines for the battery based at least in part on the user profile. Other embodiments may be described.

### RELATED APPLICATIONS

None.

### BACKGROUND

The subject matter described herein relates generally to the field of electronic devices and more particularly to a battery charge management for electronic devices.

Electronic devices such as, e.g., laptop computers, notebook computers, tablet computers, mobile phones, electronic readers, and the like have one or more batteries that need to be charged periodically. Battery charge routines that charge a battery slowly extend the lifespan of the battery, but may cause inconvenience to a user of the electronic device. By contrast, battery charge routines that charge the battery quickly may be more convenient for a user, but reduce the lifespan of the battery. Accordingly systems and methods for battery charge management may find utility.

### BRIEF DESCRIPTION OF THE DRAWINGS

The detailed description is described with reference to the accompanying figures.

FIGS. 1 and 2 are high-level schematic illustrations of electronic devices which may be adapted to include battery charge management in accordance with some embodiments.

FIG. 3 is a flowchart illustrating operations in a method for battery charge management in accordance with some embodiments.

FIGS. 4-7 are schematic illustrations of electronic devices which may include battery charge management in accordance with some embodiments.

### DETAILED DESCRIPTION

Described herein are exemplary systems and methods to implement battery charge management in electronic devices. In some embodiments described herein an electronic device may comprise one or more user profilers which collates activity usage pattern information for the electronic device and one or more location services which provide location information for the electronic device. The electronic device further includes a charge driver which receives user profile information from the user profiler and may also receive location information from the location services. The charge driver selects and implements a charge routine based at least in part on the activity usage pattern information and/or the location information. Thus, the charge driver is able to implement a context-sensitive charge routine.

In the following description, numerous specific details are set forth to provide a thorough understanding of various embodiments. However, it will, he understood by those skilled in the art that the various embodiments may be practiced without the specific details, In other instances, well-known methods, procedures, components, and circuits have not been illustrated or described in detail so as not to obscure the particular embodiments.

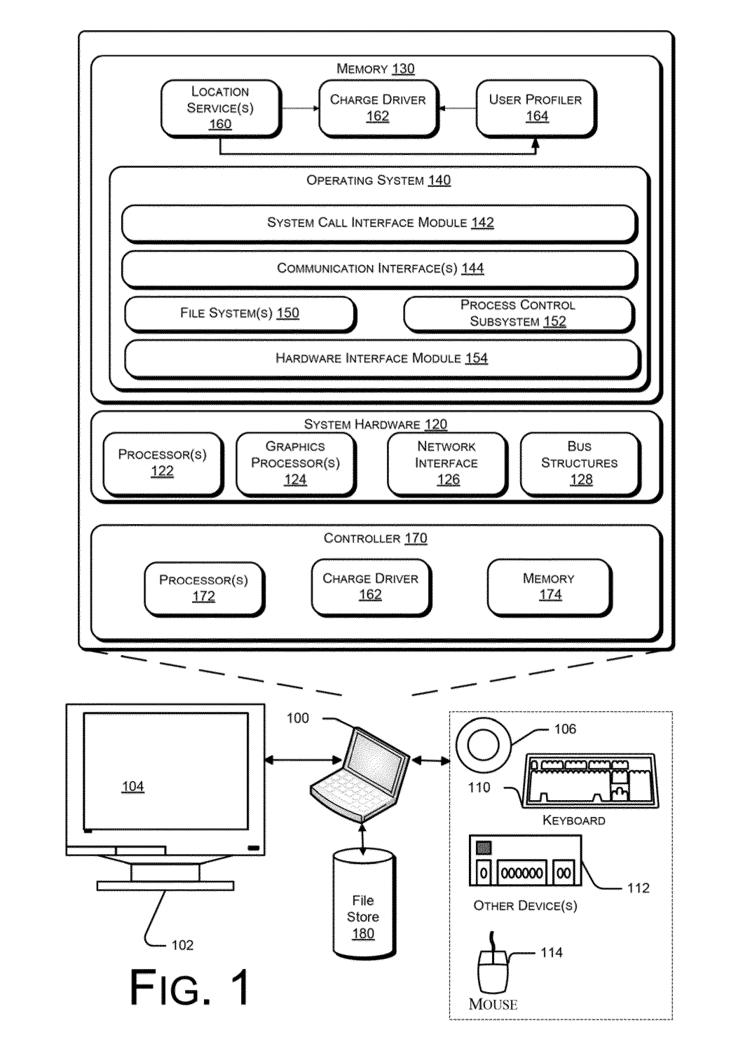

FIG. 1 is a schematic illustration of an exemplary electronic device 100 which may be adapted to implement battery charge management as described herein, in accordance with some embodiments. In one embodiment, electronic device 100 includes one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track hall, and any other device that allows the electronic device 100 to receive input from a user.

In various embodiments, the electronic device 100 may be embodied as a personal computer, a laptop computer, a personal digital assistant, a mobile telephone, an entertainment device, or another computing device.

The electronic device 100 includes system hardware 120 and memory 130, which may be implemented as random access memory and/or read-only memory. A file store 180 may be communicatively coupled to computing device 108. File store 180 may be internal to electronic device 100 such as, e.g., one or more hard drives, CD-ROM drives, DVD-ROM drives, or other types of storage devices. File store 180 may also be external to electronic device 100 such as, e.g., one or more external hard drives, network attached storage, or a separate storage network.

System hardware 120 may include one or more processors 122, one or more graphics processors 124, network interfaces 126, and bus structures 128. In one embodiment, processor 122 may be embodied as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

In some embodiments one of the processors 122 in system hardware 120 may comprise a low-power embedded processor, referred to herein as a manageability engine (ME). The manageability engine may be implemented as an independent integrated circuit, or may be a dedicated portion of a larger processor

Graphics processors) 124 may function as adjunct processor that manages graphics and/or video operations. Graphics processors) 124 may he integrated onto the motherboard of electronic device 100 or may be coupled via an expansion slot on the motherboard.

In one embodiment, network interface 126 could, be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN-Part II: Wireless LAN Medium Access Control (MAC) and Physical Layer (PHY) specifications Amendment 4: Further Higher Data Rate Extension in the 2.4 GHz Band, 802.110-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. in one embodiment, bus structures 128 may be one or more of several types of bus structure(s) including a memory bos, a peripheral bus or external bus, and/or a local bus using any variety of available bus architectures including, but not limited to, 11-bit bus. Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of electronic device 100. In one embodiment, operating system 140 includes a hardware interface module 154 that provides an interface to system hardware 120. In addition, operating system 140 may include a file system 150 that, manages files used in the operation of electronic device 100 and a process control subsystem 152 that manages processes executing on electronic device 100.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130, Operating system 140 may be embodied as a UNIX operating system or any derivative thereof (e.g., Linux, Solaris, etc.) or as a Windows® brand operating system, or other operating systems.

In some embodiments memory 130 may further comprise one or more applications which may execute on the one or more processors 122 including one or more location service(s) 160, a charge driver 162, and a user profiler 164. These applications may be embodied as logic instructions stored in a tangible, non-transitory computer readable medium (i.e., software or firmware) which may be executable on one or more of the processors 122. Alternatively, these applications may be embodied as logic on a programmable device such as a field programmable gate array (FPGA) or the like. Alternatively, these applications may be reduced to logic that may be hardwired into an integrated circuit.

Location service(s) 160 may comprise, e.g., a network-based position service such as a Global Positioning Service (GPS) module, a WiFi network locator service, or motion-based devices such as, e.g., an accelerometer, a magnetometer, a barometer, a gyroscope, a proximity detector, or the like. The location service(s) 160 may generate one or more outputs which provide location information for the electronic device 100.

User profiler 164 may monitor activity usage patterns of the electronic device and construct a user profile of the activity usage patterns. The activity usage profile may be stored in a memory, e.g., memory 130 and/or tile store 180. The activity usage patterns may be sampled regularly as the electronic device 100 is in use such that the user profile is consistently being updated with activity usage patterns. By way of example, in some embodiments the user profiler may monitor applications and/or processes executing on electronic device 100. In some embodiments the user profiler 164 may incorporate location information from the location service(s) 160 into the user profile. In some embodiments the user profiler may monitor user activity over different hours of the day that i.e., at what rate and which applications user is running over the course of the day.

Charge driver 162 receives input from location service(s) 160 and/or user profiler 164 and uses the inputs to select one of a plurality of charge routines for a battery which may be coupled to electronic device 100.

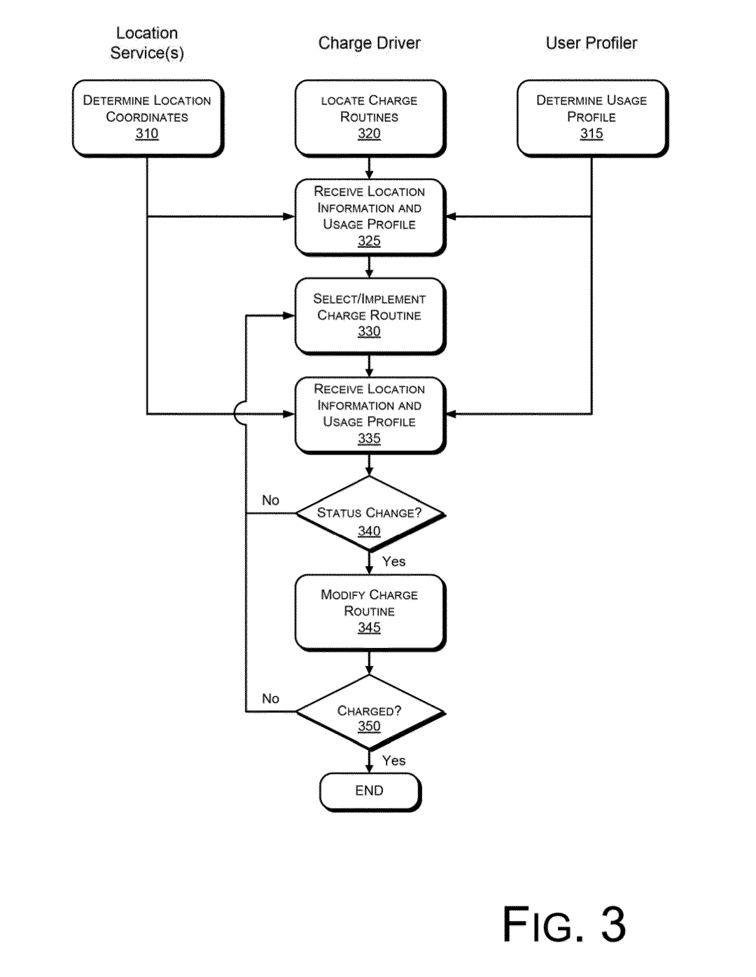

In some embodiments electronic device 100 may comprise a low-power embedded processor, referred to herein as an adjunct controller 170. The adjunct controller 170 may be implemented as an independent integrated circuit located on the motherboard of the system 100. In some embodiments the adjunct controller 170 may comprise one or more processors 172 and a memory module 174, and the charge driver 162 may be implemented in the controller 170. By way of example, the memory module 174 may comprise a persistent flash memory module and the charge driver 162 may be implemented as logic instructions encoded in the persistent memory module, e.g., firmware or software. Because the adjunct controller 170 is physically separate from the main, processors) 122 and operating system 140, the adjunct controller 170 may be made secure, i.e., inaccessible to hackers such that it cannot be tampered with. Operations implemented by charge driver 162 are described in greater detail below, with reference to FIG. 3.

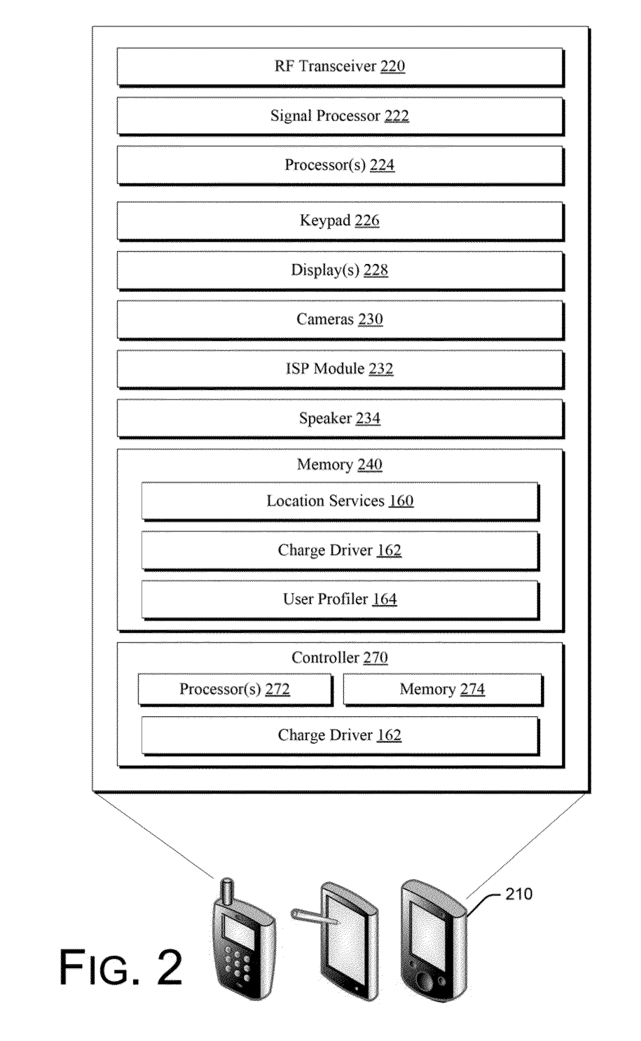

FIG. 2 is a schematic illustration of another embodiment of an electronic device 210 which may be adapted to include a backlight assembly as described herein, according to embodiments. In some embodiments electronic device 210 may be embodied as a mobile telephone, a personal digital assistant (PDA), a laptop computer, or the like. Electronic device 210 may include an RF transceiver 220 to transceive RF signals and a signal processing module 222 to process signals received by RF transceiver 220.

RF transceiver 220 may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN-Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Electronic device 210 may further include one or more processors 224 and a memory module 240. As used herein, the term “processor” means any type of computational element, such as but not limited to, a microprocessor, a microcontroller, a complex instruction set computing (CISC) microprocessor, a reduced instruction set, (RISC) microprocessor, a very long instruction word (VLIW) microprocessor, or any other type of processor or processing circuit. In some embodiments, processor 224 may be one or more processors in the family of Intel® PXA27x processors available from Intel® Corporation of Santa Clara, Calif. Alternatively, other CPUs may be used, such as Inters Itanium®, XEON™, ATOM™, and Celeron® processors. Also, one or more processors from other manufactures may be utilized. Moreover, the processors may have a single or multi core design.

In some embodiments, memory module 240 includes random access memory (RAM); however, memory module 240 may be implemented using other memory types such as dynamic RAM (DRAM), synchronous DRAM (SDRAM), and the like. Memory 240 may comprise one or more applications which execute on the processor(s) 222.

Electronic device 210 may further include one or more input/output interfaces such as, e.g., a keypad 226 and one or more displays 228. In some embodiments electronic device 210 comprises one or more camera modules 220 and an image signal processor 232, and speakers 234.

In some embodiments memory 230 may further comprise one or more applications which may execute on the one or more processors 222 including one or more location service(s) 160, a charge driver 162, and a user profiler 164, as described above with reference to FIG. 1.

In some embodiments electronic device 210 may include an adjunct controller 270 which may be implemented in a manner analogous to that of adjunct controller 170, described above, in the embodiment depicted, in FIG. 2 the adjunct controller 270 comprises one or more processors) 272 and a memory module 274, and the charge driver 164 may be implemented in the controller 170. In some embodiments the memory module 274 may comprise a persistent flash memory module and the charge driver 164 may be implemented as logic instructions encoded in the persistent memory module, e.g., firmware or software. Again, because the adjunct controller 270 is physically separate from the main processor(s) 224, the adjunct controller 270 may foe made secure, i.e., inaccessible to backers such that it cannot be tampered with.

Operations of the charge driver 162/controller 170 will be described with reference to FIG. 3. As described above, in some embodiments the location service(s) 160 may generate outputs which indicate a location of the electronic device 100, 210. By way of example, in operation 310 the location service(s) 160 may determine location information such as GPS coordinates for the electronic device 100, 210. Also as described above, in some embodiments the user profiler 164 determines a user activity profile for the electronic device 100, 210. In some embodiement user activity may include how often user is launching/running different applications and also time durations and time instant of run time of the application over a day.

Further, in some embodiments one or more charge routines may be stored in a memory of the electronic device 100, 210. By way of example, a manufacturer or distributor of an electronic device 100, 210 may load the memory of electronic device 100, 210 with a plurality of charge routines for a battery coupled to the electronic device 100, 210, The charge routines may include one or more fast-charge routines which charge the battery at a relatively high charge rate and one or more slow charge routines which charge the battery at a relatively low charge rate. The charge routine may also include using higher charging voltage for a plurality of battery types during a fast charging operation or using a reduced charging voltage for a plurality of battery types during a slower charging operation to help battery lifespan. In some embodiments charge routing may include using fast charge rate and higher charging voltage while charging during very active day time and using low charge rate and lower charging voltage while charging during a prolong non-active time/sleep time. Charge routine may be different for different types of battery.

At operation 320 the charge driver 162 locates the charge routine(s) in the memory of the electronic device 100, 210. At operation 325 the charge driver 162 may receive location information and a usage profile for the electronic device 100, 210. By way of example, in some embodiments the charge driver may obtain location information from location service(s) 160 and a user profile from the user profiler 164.

At operation 330 the charge driver 162 selects and implements a charge routine from the various charge routines stored in a memory of the electronic device 100, 210. In some embodiments the charge driver 162 selects a charge routine based at least in part on the user profile obtained by the charger driver 162, By way of example, if the user profile indicates that the electronic device 110 is in normally in a sleep mode or in a low-activity mode at a particular point in time then the charge driver 162 may select a slow charge routine such that the battery may be charged at a low charge rate or low charging voltage or low charge rate and low charging voltage. By contrast, if the user profile indicates that the electronic device 110 is in normally in an active mode at a particular point in time then the charge driver 162 may select a fast charge routine such that the battery may be charged at a higher rate or a higher charging voltage or both higher charge rate and charge voltage

In some embodiments the charge driver 162 cooperates with the user location service(s) 160 and the user profiler 164 to monitor for status changes in either the location of the device or in the user profile and to modify the charge routine in response thereto. Thus, at operation 335 the charge driver receives updated location information and user profile information. If, at operation 340, the update information does not indicate a status change for either the location or the user profile of the device then control passes back to operation 330 and the monitoring continues. By contrast, if at operation 340 the update information does indicates a status change for either the location or the user profile of the device then control passes to operation 345 and the battery charge routine is modified. By way of example, if the update information indicates that the electronic device has changed from a low-activity mode to a high activity mode then the charge routine may be revised from a slow charge routine to a fast charge routine. Similarly, if the update information indicates that the electronic device 100, 210 has moved from a location in which the electronically in a low-activity mode to a location in which the electronic device 100, 210 is in a high-activity mode then the charge routine may he revised from a slow charge routine to a fast charge routine. One skilled in the art will recognize that if the updates indicate the opposite then the charge routine may he revised from a fast charge routine to a slow charge routine.

If, at operation 350, the battery is not charged then control passes back to operation 330 and the charge routine continues. By contrast, if at operation 350 the battery is charged then the charge routine may end. Thus, operations 330-350 implement a loop pursuant to which the charge driver 162 may modify the charge routine to accommodate changes in the device status.

Thus, the operations depicted in FIG. 3 enable a controller to implement battery charge management for an electronic device. More particularly, the operations depicted in FIG. 3 enable a user to establish one or more user profiles which may include charge routines that are based in part on location and or usage patterns. For example, low voltage, slow charging rates may be implemented during sleep time at a location determined based on GPS data and clock data. By contrast, faster charging routines which use higher voltages may be used during active periods of time.

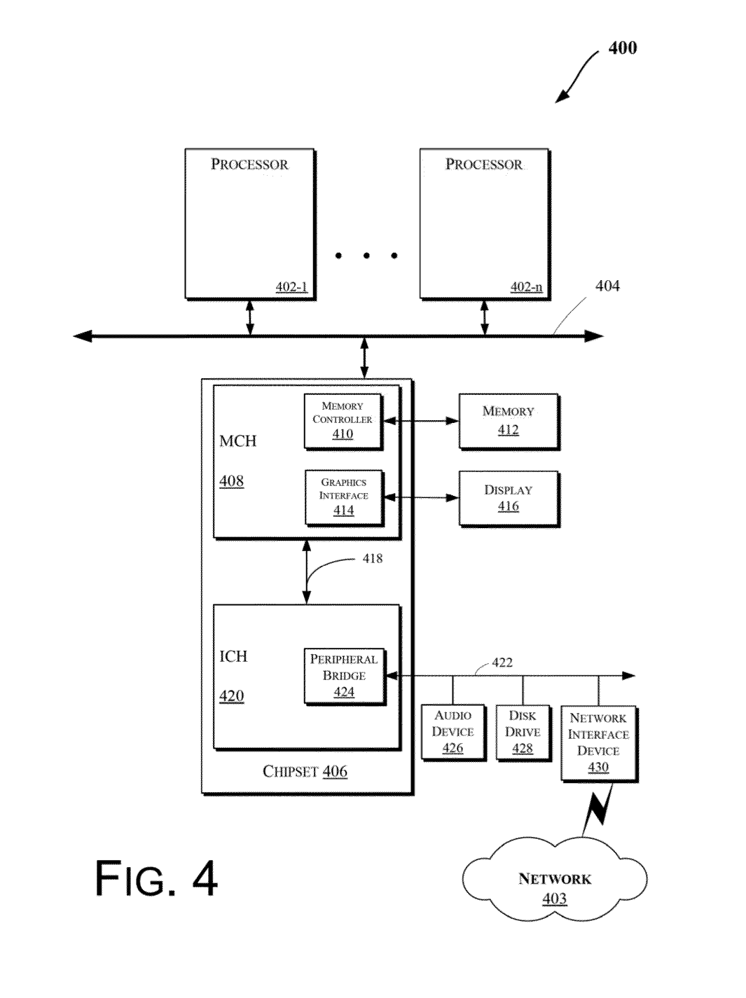

As described above, in some embodiments the electronic device may be embodied as a computer system. FIG. 4 illustrates a block diagram of a computing system 400 in accordance with an embodiment of the invention. The computing system 400 may include one or more central processing unit(s) (CPUs) 402 or processors that communicate via an interconnection network (or bus) 404. The processors 402 may include a general purpose processor, a network processor (that processes data communicated over a computer network 403), or other types of a processor (including a reduced instruction set computer (RISC) processor or a complex instruction set computer (CISC)). Moreover, the processors 402 may have a single or multiple core design. The processors 402 with, a multiple core design may integrate different types of processor cores on the same integrated circuit (IC) die. Also, the processors 402 with a multiple core design may be implemented as symmetrical or asymmetrical multiprocessors. In an embodiment, one or more of the processors 402 may be the same or similar to the processors 102 of FIG. 1. For example, one or more of the processors 402 may include the control unit 120 discussed with reference to FIGS. 1-3. Also, the operations discussed with reference to FIGS. 1-3 may be performed by one or more components of the system 400.

A chipset 406 may also communicate with the interconnection network 404. The chipset 406 may include a memory control hub (MCH) 408. The MCH 408 may include a memory controller 410 that communicates with a memory 412 (which may be the same or similar to the memory 114 of FIG. 1). The memory 412 may store data, including sequences of instructions, that may be executed by the CPU 402, or any other device included In the computing system 400. In one embodiment of the invention, the memory 412 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 404, such as multiple CPUs and/or multiple system memories.

The MCH 408 may also include a graphics interface 414 that communicates with a display device 416, In one embodiment of the invention, the graphics interface 414 may communicate with the display device 416 via an accelerated graphics port (AGP). In an embodiment of the invention, the display 416 (such as a flat panel display) may communicate with the graphics interface 414 through, for example, a signal converter that translates a digital representation of an image stored in a storage device such as video memory or system memory into display signals that are interpreted and displayed, by the display 416. The display signals produced by the display device may pass through various control devices before being interpreted by and subsequently displayed on the display 416.

A hub interface 418 may allow the MCH 408 and an input output control hub (ICH) 420 to communicate. The ICH 420 may provide an interface to I/O device(s) that communicate with the computing system 400. The ICR 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the CPU 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and a network interface device 430 (which is in communication with the computer network 403). Other devices may communicate via the bus 422, Also, various components (such as the network interface device 430) may communicate with the MCH 408 in some embodiments of the invention. In addition, the processor 402 and one or more other components discussed herein may be combined to form a single chip (e.g., to provide a System on Chip (SOC)). Furthermore, the graphics accelerator 416 may be included within the MCH 408 in other embodiments of the invention.

Furthermore, the comparing system 400 may include volatile and/or nonvolatile memory for storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

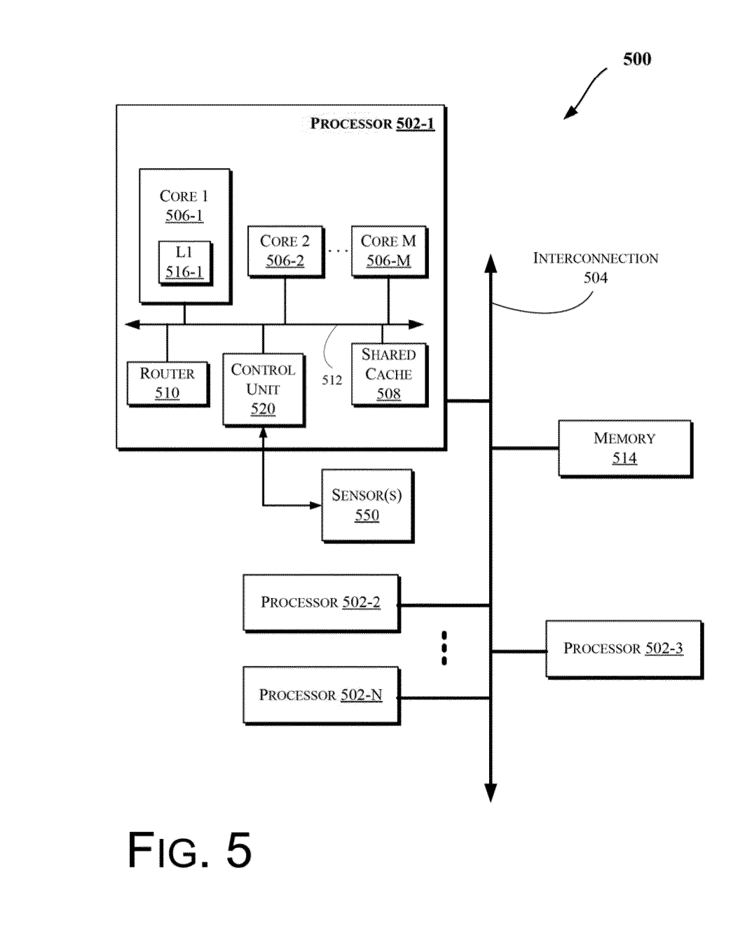

FIG. 5 illustrates a block diagram of a computing system 500, according to an embodiment of the invention. The system 500 may include one or more processors 502-1 through 502-N (generally referred to herein as “processors 502” or “processor 502”). The processors 502 may communicate via an interconnection network or bus 504. Each processor may include various components some of which are only discussed with reference to processor 502-1 for clarity. Accordingly, each of the remaining processors 502-2 through 502-N may include the same or similar components discussed with reference to the processor 502-1.

In an embodiment, the processor 502-1 may include one or more processor cores 506-1 through 506-M (referred to herein as “cores 506” or more generally as “core 506”), a shared cache 508, a router 510, and/or a processor control, logic or unit 520, The processor cores 506 may be implemented on a single integrated circuit (IC) chip. Moreover, the chip may include one or more shared and/or private caches (such as cache 508), buses or interconnections (such as a bus or interconnection network 512), memory controllers (such as those discussed with reference to FIGS. 4-5), or other components.

In one embodiment, the router 510 may be used to communicate between various components of the processor 502-1 and/or system 500. Moreover, the processor 502-1 may include more than one router 510. Furthermore, the multitude of routers 510 may he in communication to enable data routing between various components inside or outside of the processor 502-1.

The shared cache 508 may store data (e.g., including instructions) that are utilized by one or more components of the processor 502-1, such as the cores 506. For example, the shared cache 508 may locally cache data stored in a memory 514 for faster access by components of the processor 502. In an embodiment, the cache 508 may include a mid-level cache (such as a level 2 (L2), a level 3 (L3), a level 4 (L4), or other levels of cache), a last level cache (LLC), and/or combinations thereof. Moreover, various components of the processor 502-1 may communicate with the shared cache 508 directly, through a bus (e.g., the bus 512), and/or a memory controller or hub. As shown in FIG. 5, in some embodiments, one or more of the cores 506 may include a level 1 (L1) cache 516-1 (generally referred to herein as “L1 cache 516”). In one embodiment, the controller 520 may include logic to implement the operations described above with reference to FIG. 3.

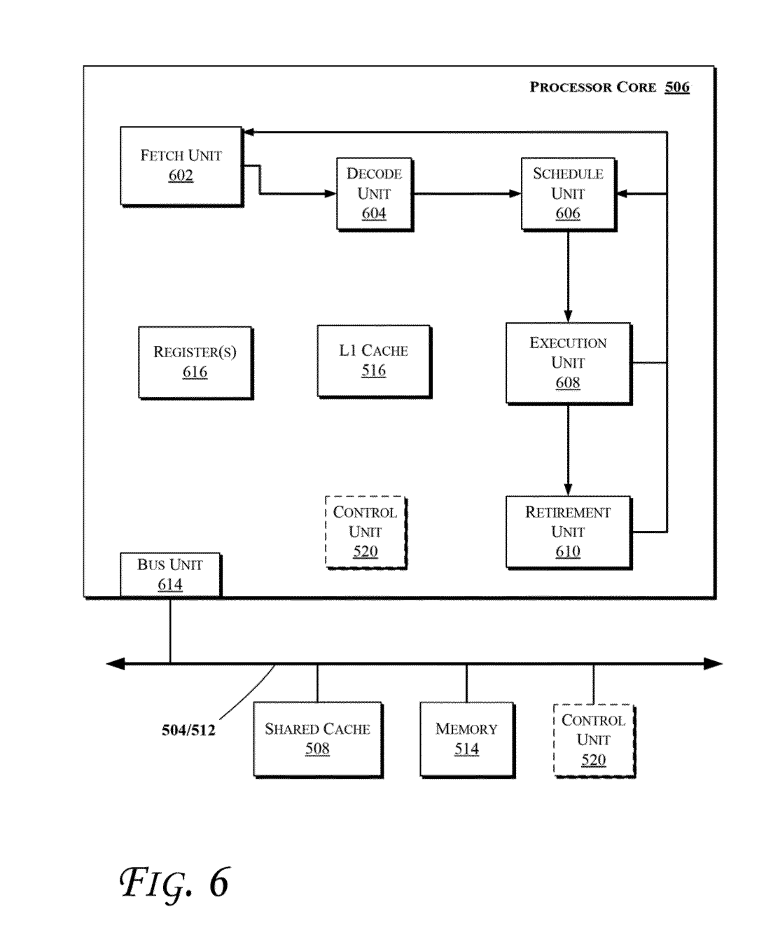

FIG. 6 illustrates a block diagram of portions of a processor core 506 and other components of a computing system, according to an embodiment of the invention. In one embodiment, the arrows shown in FIG. 6 illustrate the flow direction of instructions through the core 106. One or more processor cores (such as the processor core 106) may be implemented on a single integrated circuit chip (or die) such as discussed with reference to FIG. 5. Moreover, the chip may include one or more shared and/or private caches (e.g., cache 508 of FIG. 5), interconnections (e.g., interconnections 504 and/or 112 of FIG. 5), control units, memory controllers, or other components.

As illustrated in FIG. 6, the processor core 506 may include a fetch unit 602 to fetch instructions (including instructions with conditional branches) for execution by the core 606. The instructions may be fetched from any storage devices such as the memory 514. The core 506 may also include a decode unit 604 to decode the fetched instruction. For instance, the decode unit 604 may decode the fetched instruction into a plurality of uops (micro-operations).

Additionally, the core 606 may include a schedule unit 606. The schedule unit 606 may perform various operations associated with storing decoded instructions (e.g., received from the decode unit 604) until the instructions are ready for dispatch, e.g., until all source values of a decoded instruction become available.

In one embodiment, the schedule unit 606 may schedule and/or issue (or dispatch) decoded instructions to an execution unit 608 for execution. The execution unit 60S may execute the dispatched instructions after they are decoded (e.g., by the decode unit 604) and dispatched (e.g., by the schedule unit 606). In an embodiment, the execution unit 608 may include more than one execution unit. The execution unit 608 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 608.

Further, the execution unit 608 may execute instructions out-of-order. Hence, the processor core 506 may be an out-of-order processor core in one embodiment. The core 506 may also include a retirement unit 610. The retirement unit 610 may retire executed instructions after they are committed. In an embodiment, retirement of the executed instructions may result in processor state being committed from the execution of the instructions, physical registers used by the instructions being de-allocated, etc.

The core 106 may also include a bus unit 614 to enable communication between components of the processor core 506 and other components (such as the components discussed with reference to FIG. 6) via one or more buses (e.g., buses 604 and/or 612). The core 106 may also include one or more registers 616 to store data accessed by various components of the core 506 (such as values related to power consumption state settings),

Furthermore, even though FIG. 5 illustrates the control unit 520 to be coupled to the core 506 via interconnect 512, in various embodiments the control unit 520 may be located elsewhere such as inside the core 506, coupled to the core via bus 504, etc.

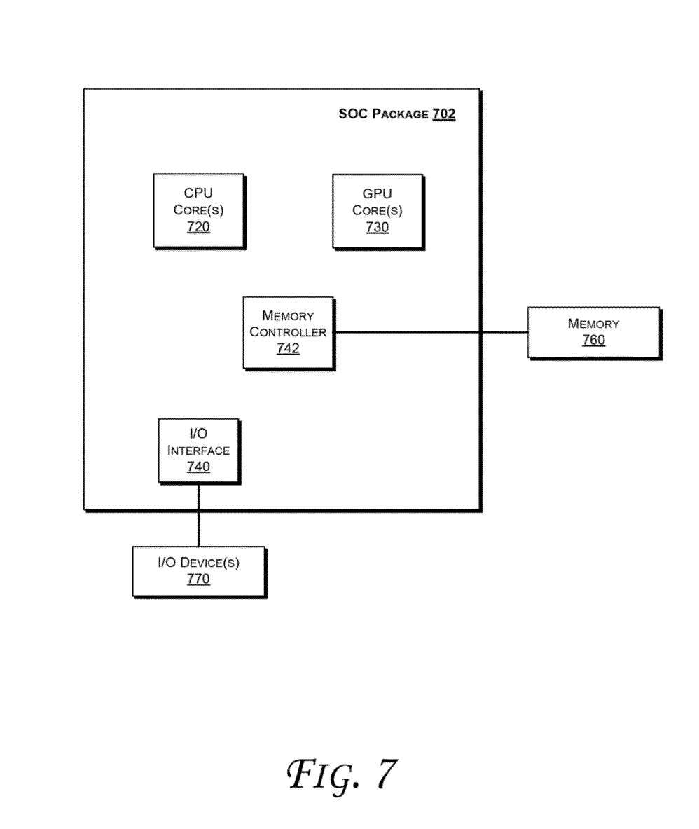

In some embodiments, one or more of the components discussed herein can be embodied as a System On Chip (SOC) device. FIG. 7 illustrates a block diagram of an SOC package in accordance with an embodiment. As illustrated in FIG. 7, SOC 702 includes one or more Central Processing Unit (CPU) cores 720, one or more Graphics Processor Unit (GPU) cores 730, an Input-Output (I/O) interface 740, and a memory controller 742. Various components of the SOC package 702 may be coupled to an interconnect or bus such as discussed herein with reference to the other figures. Also, the SOC package 702 may include more or less components, such as those discussed herein with reference to the other figures. Further, each component of the SOC package 720 may include one or more other components, e.g., as discussed with reference to the other figures herein, in one embodiment, SOC package 702 (and its components) is provided on one or more Integrated Circuit (IC) die, e.g., which are packaged into a single semiconductor device.

As illustrated in FIG. 7, SOC package 702 is coupled to a memory 760 (which may be similar to or the same as memory discussed herein with reference to the other figures) via the memory controller 742. In an embodiment the memory 760 (or a portion of it) can be integrated on the SOC package 702.

The I/O interface 740 may be coupled to one or more TO devices 770, e.g., via an interconnect and/or bus such as discussed herein with reference to other figures. I/O device(s) 770 may include one or more of a keyboard, a mouse, a touchpad, a display, an image/video capture device (such as a camera or camcorder/video recorder), a touch screen, a speaker, or the like.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output; or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described, methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method, comprising:
receiving, in a controller, a user profile for usage of an electronic device, the electronic device at least partially powered by a battery; and
implementing, in the controller, a selected charge routine from a plurality of charge routines for the battery based at least in part on the user profile.

2. The method of claim 1, further comprising retrieving the selected charge routine from a memory based at least in part on the user profile.

3. The method of claim 1, further comprising:
monitoring, in a user profiler, activity usage patterns for the electronic device;
constructing the user profile from the activity usage patterns; and
storing the user profile in a memory,

4. The method of claim 3, wherein receiving, in the controller, a user profile for usage of an electronic device comprises retrieving the user profile from the memory.

5. The method of claim 1, further comprising:
receiving, in the controller, location information for the electronic device; and
implementing, in the controller, a selected charge routine from one of the plurality of charge routines based at least in part on the location information.

6. The method of claim 5, further comprising:
receiving, in the controller, an update for at least one of the user profile or the location information for the electronic device, the electronic device at least partially powered by a battery; and
modifying, in the controller, the selected charge routine based at least in pan on the user profile or the location information.

7. The method of claim 1, further comprising:
terminating the selected charge routine when the battery charge meets a charge threshold.

8. A controller comprising logic to:
receive a user profile for usage of an electronic device the electronic device at least partially powered by a battery; and
implement a selected charge routine from a plurality of charge routines for the battery based at least in part on the user profile.

9. The controller of claim 8, comprising logic to:
retrieve the selected charge routine from a memory based at least in part on the user profile.

10. The controller of claim 8, comprising logic to:
monitor, in a user profiler, activity usage patterns for the electronic device;
construct the user profile from the activity usage patterns; and
store the user profile in a memory.

11. The controller of claim 10, comprising logic to retrieve the user profile from the memory.

12. The controller of claim 8, further comprising logic to:
receive location information for the electronic device; and
implement, in the controller, a selected charge routine from one of the plurality of charge routines based at least in part on the location information.

13. The controller of claim 12, further comprising logic to:
receive an update for at least one of the user profile or the location information for the electronic device, the electronic device at least partially powered by a battery; and
modify the selected charge routine based at least in part on the user profile or the location information.

14. The controller of claim 1, further comprising logic to:
terminate the selected charge routine when the battery charge meets a charge threshold.

15. An electronic device, comprising:
a battery;
a controller comprising logic to:
receive a user profile for usage of an electronic device, the electronic device at least partially powered by a battery; and
implement a selected charge routine from a plurality of charge routines for the battery based at least in part on the user profile.

16. The electronic device of claim 15, comprising logic to:
retrieve the selected charge routine from a memory based at least in part on the user profile.

17. The electronic device of claim 15, comprising logic to:
monitor, in a user profiler, activity usage patterns for the electronic device; construct the user profile from the activity usage patterns; and
store the user profile in a memory,

18. The electronic device of claim 17, comprising logic to retrieve the user profile from the memory.

19. The electronic device of claim 15, further comprising logic to:
receive location information for the electronic device; and
implement, in the controller, a selected charge routine from one of the plurality of charge routines based at least in part on the location information,

20. The electronic device of claim 19, further comprising logic to:
receive an update for at least one of the user profile or the location information for the electronic device, the electronic device at least partially powered by a battery; and
modify the selected charge routine based at least in part on the user profile or the location information.

21. The electronic device of claim 15, further comprising logic to:
terminate the selected charge routine when the battery charge meets a charge threshold.
